(19) United States
(12) Patent Application Publication
(10) Pub. No.: US 2008/0001830 A1
(43) Pub. Date: Jan. 3, 2008

(54) Folding Portable Wireless Device

(75) Inventors: Masayoshi Hirai, Kanagawa (JP); Nobuharu Mashima, Toyama (JP); Masanori Kubota, Kanagawa (JP); Yutaka Isoda, Kanagawa (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 11/572,713

(22) PCT Filed: Jul. 28, 2005
(86) PCT No.: PCT/JP05/13873

§ 371 Date: Jan. 26, 2007

(30) Foreign Application Priority Data
Jul. 29, 2004 (JP) 2004-221260

(51) Int. Cl. H01Q 1/22

(52) U.S. Cl. 343/702

(57) ABSTRACT

To provide a folding-type portable wireless equipment which can obtain good antenna performance in a folding-type portable wireless equipment having the structure for opening and closing cases by using a bendable plane-shaped coupling member.

A folding-type portable wireless equipment 100 includes a first circuit board 101 disposed in a first case 11, a second circuit board 102 disposed in a second case 12, a coupling portion 13 constituting a bendable plane-shaped coupling member which mechanically couples the first case 11 and the second case 12, a flexible element 103 which electrically couples the first circuit board 101 and the second circuit board 102, a radio circuit portion 106 provided at the second circuit board 102 and an antenna element 104 coupled to the radio circuit portion 106, wherein the antenna element 104 is disposed at a position almost along the coupling portion 13, and the tip end portion of the antenna element 104 is disposed at a position most away from the first circuit board 101 and the second circuit board 102 in the closed state of the folding-type portable wireless equipment 100.

### TECHNICAL FIELD

The present invention relates a folding-type portable wireless equipment having an antenna for radio communication, in which two cases are coupled to each other via a bendable plane-shaped coupling member so as to be opened and closed.

### BACKGROUND ART

In portable telephones etc., folding-type portable wireless equipments have been widely used in each of which two cases are coupled to each other via a hinge portion etc. so as to be opened and closed. In such a kind of folding-type portable wireless equipment, a hinge mechanism in which a coupling portion of the cases rotates is used generally (see patent document 1, for example). The folding-type portable wireless equipment having such a hinge mechanism has a structure that an extensible antenna is disposed at an upper case or a lower case. Further, there is proposed an electronic device having a structure that the holding of the opened/closed state of cases is realized by using a bendable plane-shaped coupling member in place of a hinge mechanism (see patent document 2, for example).

Patent Document 1: JP-A-2001-45123

Patent Document 2: JP-A-5-259656

### DISCLOSURE OF THE INVENTION

<Problems that the Invention is to Solve>

However, the configuration of the electronic device like the conventional example has a problem that an antenna necessary in the case of being applied to a portable wireless equipment can not be provided easily and necessary antenna performance can not be secured.

The invention is made in view of the aforesaid circumstance and an object of the invention is to provide a folding-type portable wireless equipment which can obtain good antenna performance in a folding-type portable wireless equipment having the structure for opening and closing cases by using a bendable plane-shaped coupling member.

<Means for Solving the Problem>

The folding-type portable wireless equipment according to the invention is a folding-type portable wireless equipment having a first case and a second case, which includes:

a first circuit board disposed in the first case;

a second circuit board disposed in the second case;

a bendable plane-shaped coupling member which mechanically couples the first case and the second case;

a flexible coupling conductor which electrically couples the first circuit board and the second circuit board;

a radio circuit portion provided at the second circuit board; and

an antenna coupled to the radio circuit portion, wherein

the antenna is disposed at a position almost along the plane-shaped coupling portion, and a tip end portion of the antenna is disposed at a position most away from the first circuit board and the second circuit board in a closed state of the folding-type portable wireless equipment.

According to this configuration, it is possible to obtain good antenna characteristics in each of the opened and closed states in the configuration of opening and closing the cases by using the bendable plane-shaped coupling member.

The folding-type portable wireless equipment according to the invention further includes a holding member which is fixed to the first case and the second case and holds an opened state of the folding-type portable wireless equipment, wherein

the antenna is disposed at a position that the antenna does not overlap with the holding member nor the coupling conductor when viewed from a direction perpendicular to a plane of the portable wireless equipment in the opened state and the tip end portion of the antenna is directed to a direction in opposite to a direction to which the holding member and the coupling conductor are disposed.

According to this configuration, high antenna performance can be secured.

Further, the folding-type portable wireless equipment according to the invention is arranged in a manner that the holding member is fixed to the first case and the second case at a position spaced with a predetermined distance from the first circuit board and the second circuit board.

According to this configuration, high antenna performance can be secured.

Further, the folding-type portable wireless equipment according to the invention is arranged in a manner that a part of the antenna is disposed so as to protrude from an area sandwiched between the first circuit board and the second circuit board when viewed from a direction perpendicular to a plane of the portable wireless equipment in the opened state.

According to this configuration, high antenna performance can be secured.

### ADVANTAGES OF THE INVENTION

According to the invention, it is possible to provide the folding-type portable wireless equipment which can obtain good antenna performance in the folding-type portable wireless equipment having the structure for opening and closing the cases by using the bendable plane-shaped coupling member.

### BRIEF DESCRIPTION OF THE DRAWINGS

FIG. 1 is a perspective view showing the external configuration of a folding-type portable wireless equipment in order to explain the embodiment of the invention.

FIG. 2 is a front view showing the configuration of a main portion of the folding-type portable wireless equipment in an opened state thereof in order to explain the embodiment of the invention.

FIG. 3 is a side view showing the configuration of the main portion of the folding-type portable wireless equipment in the opened state thereof in order to explain the embodiment of the invention.

FIG. 4 is a side view showing the configuration of the main portion of the folding-type portable wireless equipment in a closed state thereof in order to explain the embodiment of the invention.

FIG. 5 is a perspective view showing the configuration of the main portion of the folding-type portable wireless equipment in the closed state thereof in order to explain the embodiment of the invention.

### DESCRIPTION OF REFERENCE NUMERALS

100 folding-type portable wireless equipment
11 first case
12 second case
13 coupling portion
101 first circuit board
102 second circuit board
103 coupling element
104 antenna element
105 holding member
106 radio circuit portion
   <Best Mode for Carrying Out the Invention>

Hereinafter, the explanation will be made with reference to drawings as to a folding-type portable wireless equipment represented by a portable telephone etc. in order to explain an embodiment of the invention.

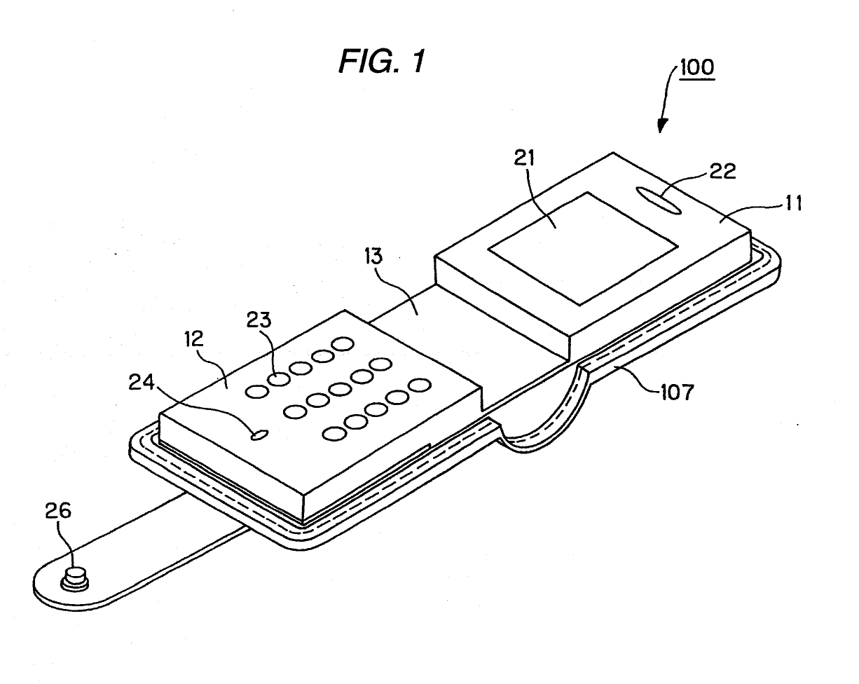

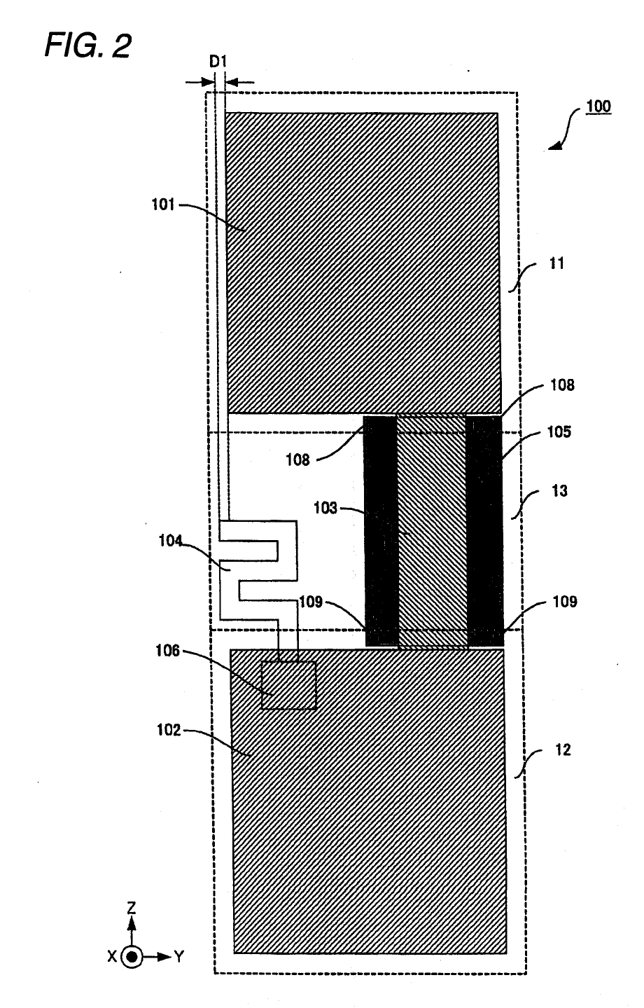

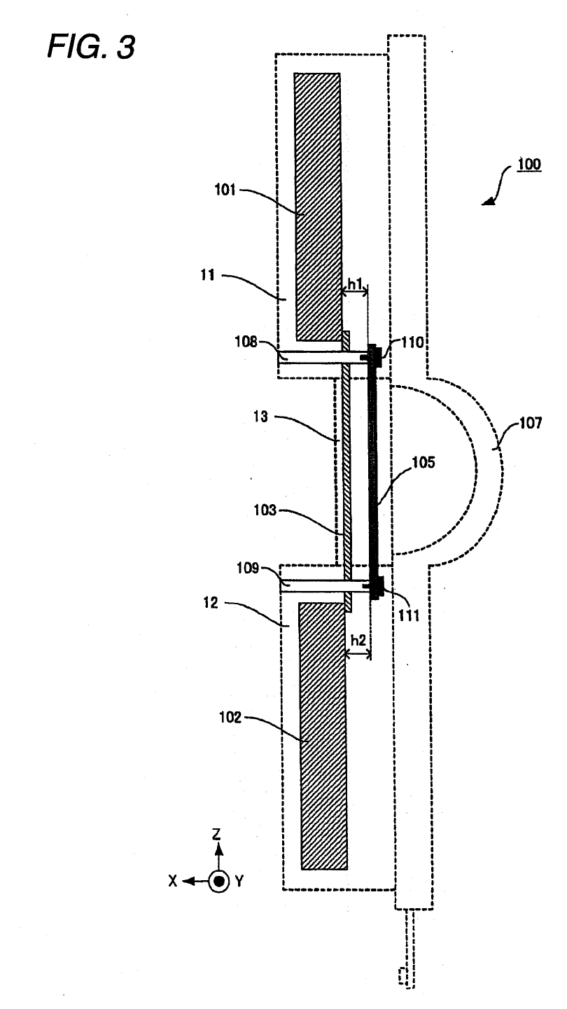

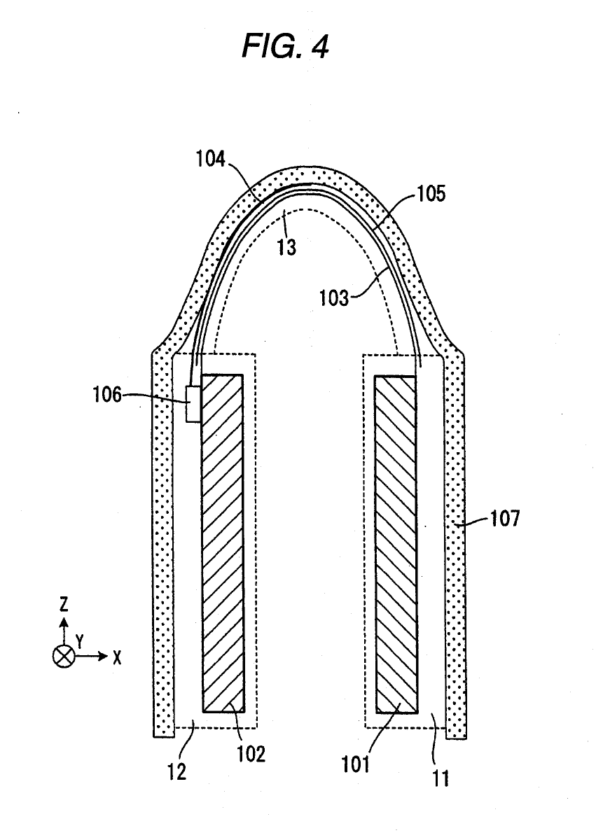

FIG. 1 is a perspective view showing the external configuration of a folding-type portable wireless equipment in order to explain the embodiment of the invention. FIG. 2 is a front view showing the configuration of a main portion of the folding-type portable wireless equipment in an opened state thereof in order to explain the embodiment of the invention. FIG. 3 is a side view showing the configuration of the main portion of the folding-type portable wireless equipment in the opened state thereof in order to explain the embodiment of the invention. FIG. 4 is a side view showing the configuration of the main portion of the folding-type portable wireless equipment in a closed state thereof in order to explain the embodiment of the invention.

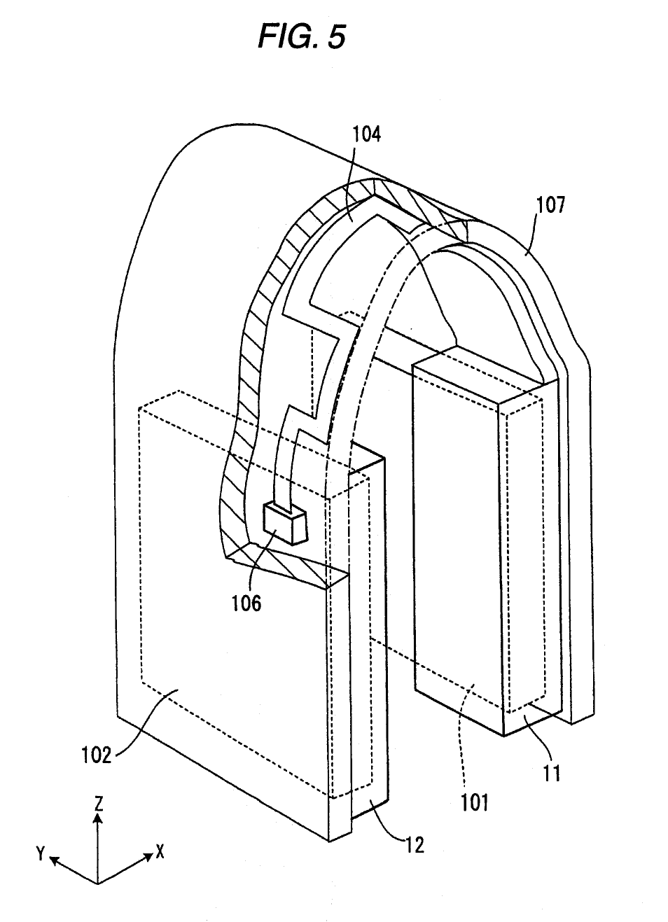

FIG. 5 is a perspective view showing the configuration of the main portion of the folding-type portable wireless equipment in the closed state thereof in order to explain the embodiment of the invention.

As shown in FIG. 1, the folding-type portable wireless equipment according to the embodiment includes a first case 11 and a second case 12. The wireless equipment is configured in a manner that the first case 11 and the second case 12 are coupled to each other via a coupling portion 13 constituting a bendable plane-shaped coupling member 13 so as to be able to bend (bend or curve) the first case 11 and the second case 12, whereby the coupling portion 13 is bendable so as to take the closed state where the first case 11 and the second case 12 are opposed and overlapped and take the opened state where the first case 11 and the second case 12 are not opposed nor overlapped. That is, the wireless equipment is configured so as to be able to fold.

The first case 11 is provided with a display portion 21 constituted by a liquid display device etc. and a receiver 22 etc. The second case 12 is provided with an operation portion 23 having a plurality of operation key buttons and a microphone 24 etc. The first case 11, the second case 12 and the coupling portion 13 are covered by a protection cover 107. Each of the first case 11 and the second case 12 is formed by soft resin, for example, and the size thereof is set to have a length of 70 mm and a width of 40 mm.

The coupling portion 13 has an exterior portion which is formed by polymer material etc. with flexibility and includes therein a flexible wiring cable, an antennal element 104, and a holding member 105 (see FIG. 2) formed by a metal plate etc. which has flexibility and couples the first case 11 and the second case 12 thereby to hold the opened state of the cases, and so on. The coupling portion 13 couples the short side portions of the first case 11 and the second case 12 each having a rectangular shape.

The protection cover 107 is configured by non-conductive material with flexibility. For example, the protection cover 107 is formed by a cloth material with a thickness of about 1 mm and disposed so as to cover the entirety of the folding-type portable wireless equipment 100. A fixing member 26 for holding the opened state of the cases is protrusively provided at the one end portion of the protection cover 107 so as to engage with a not-shown fixing member provided at the other end portion thereof.

As shown in FIGS. 2 to 4, the first case 11 and the second case 12 are coupled by the holding member 105. The holding member 105 is formed by metal material with a length of 60 mm, a width of 20 mm and a thickness of 0.2 mm, for example. The holding member 105 is not disposed at the entirety within the coupling portion 13 but disposed at a part within the coupling portion (for example, within the right half portion of the coupling portion 13 as shown in FIG. 2).

As shown in FIG. 3, the end portion on the first case 11 side of the holding member 105 is attached to a non-conductive member 108 provided within the first case 11 by means of attachment members 110 such as screws so as to be away from a first circuit board 101 by a distance h1 in the −X direction. The end portion on the second case 12 side of the holding member 105 is attached to a non-conductive member 109 provided within the second case 12 by means of attachment members 111 such as screws so as to be away from a second circuit board 102 by a distance h2 in the −X direction. Each of the distances h1 and h2 is set to be 2 mm, for example. The non-conductive members 108 and 109 can be formed by using parts of the first case 11 and the second case 12, respectively.

As shown in FIGS. 2 to 4, the first circuit board 101 and the second circuit board 102 are housed within the first case 11 and the second case 12, respectively. The first circuit board 101 and the second circuit board 102 are electrically coupled by a flexible coupling element 103 which serves as a coupling conductor provided at the coupling portion 13. Each of the first circuit board 101 and the second circuit board 102 is formed by a printed board with a thickness of 1 mm, for examples and the size of the printed board is set to have a length of 65 mm and a width of 40 mm. The coupling element 103 is configured by a flexible board with a length of 50 mm and a width of 10 mm, for example, and is disposed so as to be housed within the width of the holding member 105 in the Y direction in FIG. 2.

A grand pattern is formed on the first circuit board 101. A grand pattern is also formed on the second circuit board 102 and further a radio circuit portion 106 etc. for feeding to the antenna element 104 is provided on the second circuit board.

The antenna element 104 is formed by a line of a meander shape, for example, and is disposed between the first circuit board 101 and the second circuit board 102 at the holding member 105 side portion of the coupling portion 13. The size of the antenna element 104 is set to have a length of 20 mm, a width of 10 mm, an entire length of 90 mm, a line width of 2 mm and a line interval of 2 mm, for example.

The coupling element 103, the antenna element 104 and the holding member 105 are disposed at positions almost along the coupling portion 13 constituting the plane-shaped coupling member. The position of the antenna element 104 is set to a position where the antenna element does not overlap with the holding member 105 when viewed from the direction perpendicular to the plane of the antenna element. Further, in the closed state shown in FIG. 4, the tip end portion of the antenna element (for example, the center of the line width at the portion of the length of 2 mm from the tip end of the antenna element 104) is set to be most away from the first circuit board 101 and the second circuit board 102. The position where the tip end portion is most away from the first circuit board 101 and the second circuit board 102 is the position within the coupling portion 13 at which the distance from the first circuit board 101 is equal to the distance from the second circuit board 102 and the distance from the protection cover 107 is closest. For example, in the state shown in FIG. 4, this position is a position which is on a linear line extending from the center position between the first circuit board 101 and the second circuit board 102 opposing to each other toward the Z direction in FIG. 4 and crosses with the coupling portion 13 and is located on the outer side (the protection cover 107 side) than the holding member 105. In the aforesaid explanation, although the tip end portion is set to the center of the line width, the tip end portion is not limited to the center. For example, the tip end portion may be anywhere so long as it is located at a position away from the tip end by 2 mm.

As shown in FIG. 2, the antenna element 104 is disposed in a manner that the tip end portion thereof is directed to the side in opposite to the side where the coupling element 103 and the holding member 105 are disposed. A portion (for example, the tip end portion) of the antenna element 104 is disposed so as to protrude by a predetermined distance D1 from the area sandwiched between the first circuit board 101 and the second circuit board 102 when viewed from the direction perpendicular to the plane of the antenna element in FIG. 2. The predetermined distance D1 is set to be 2 mm, for example.

In the folding-type portable wireless equipment 100 configured in the aforesaid manner, since the antenna element 104 is disposed between the first circuit board 101 and the second circuit board 102 in the opened state shown in FIG. 2, the antenna can be configured by the electromagnetic coupling between the antenna element 104 and the first circuit board 101. On the other hand, in the closed state shown in FIGS. 4 and 5, the antenna element 104 can constitute the antenna which is disposed at the position outside of the end portion of the second circuit board 102 in the longitudinal direction thereof, whereby the degradation of the antenna performance can be prevented.

Further, in the closed state shown in FIGS. 4 and 5, since the tip end portion of the antenna element is set to be most away from the first circuit board 101 and the second circuit board 102, the degree of the resistance of radio wave irradiated from the antenna element 104 can be reduced and so high antenna performance can be secured.

Further, in each of the closed and opened states, since the tip end portion of the antenna element 104 is directed to the direction in opposite to the direction to which the holding member 105 is disposed, the degree of the influence of the holding member 105 and the coupling element 103 each serving as a resistance element with respect to radio wave irradiated from the antenna element 104 can be reduced and so high antenna performance can be secured.

Furthermore, in each of the closed and opened states, the tip end portion of the antenna element 104 is disposed so as to protrude by the predetermined distance from the area sandwiched between the first circuit board 101 and the second circuit board 102 when viewed from the direction perpendicular to the plane of the antenna element in FIG. 2. Thus, the degree of the influence of the holding member 105, the coupling element 103, the first circuit board 101 and the second circuit board 102 each serving as the resistance element with respect to radio wave irradiated from the antenna element 104 can be reduced and so high antenna performance can be secured.

Furthermore, in each of the closed and opened states, since the holding member 105 is disposed at the position separated by the predetermined distance from the first circuit board 101 and the second circuit board 102, the degree of the influence of the grand patterns of the first circuit board 101 and the second circuit board 102 acting on the holding member 105 can be made small. As a result, the resistance value of the holding member 105 serving as the resistance element with respect to radio wave irradiated from the antenna element 104 can be reduced and so high antenna performance can be secured.

As described above, according to the folding-type portable wireless equipment 100, good antenna performance can be obtained in each of the opened and closed states.

Although the explanation is made as to the configuration that the antenna element 104 is disposed almost along the coupling portion 13 within the coupling portion 13, the antenna element may not be disposed within the coupling portion. For example, the antenna element 104 may be provided along the rear surface of the coupling portion 13. Further, although the explanation is made as to the configuration that the antenna element 104 is formed by the line of a meander shape, the shape of the antenna is not limited thereto so long as the condition of the location of the antenna element 104 is satisfied. Furthermore, although the explanation is made as to the configuration that the coupling portion 13 constitutes the bendable plane-shaped coupling member, the protection cover 107 may be used so as to act as the coupling portion 13, for example.

Although the invention has been explained in detail with reference to the particular embodiment, it should be obvious for those skilled in the art that various changes and modifications may be made without departing from the spirit and the scope of the invention.

The present application is based on Japanese Patent application No. 2004-221260 filed on Jul. 29, 2004, the content of which is hereby incorporated by reference into this application.

### INDUSTRIAL APPLICABILITY

The invention has the effects that the antenna performance can be improved in the folding-type portable wireless equipment having the structure that the bendable plane-shaped coupling member is used for the opening and closing mechanism of the cases. The invention is useful for the folding-type portable wireless equipment having the radio communication antenna in which the two cases are coupled to each other by the plane-shaped coupling member so as to be able to open and close.

1-4. (canceled)

5. A folding-type portable wireless equipment including a first case and a second case, comprising:
a first circuit board disposed in the first case;
a second circuit board disposed in the second case;
a bendable plane-shaped coupling member which mechanically couples the first case and the second case;
a flexible coupling member conductor which electrically couples the first circuit board and the second circuit board;
a radio circuit portion provided at the second circuit board; and
an antenna coupled to the radio portion, wherein
the antenna is disposed at a position almost along the plane-shaped coupling portion, and a tip end portion of the antenna is disposed at a position most away from the first circuit board and the second circuit board in a closed state of the folding-type portable wireless equipment.

6. The folding-type portable wireless equipment according to claim 5, further comprising:
a holding member which is fixed to the first case and the second case and holds an opened state of the folding-type portable wireless equipment, wherein
the antenna is disposed at a position that the antenna does not overlap with the holding member nor the coupling conductor when viewed from a direction perpendicular to a plane of the portable wireless equipment in the opened state and the tip end portion of the antenna is directed to a direction in opposite to a direction to which the holding member and the coupling conductor are disposed.

7. The folding-type portable wireless equipment according to claim 6, wherein the holding member is fixed to the first case and the second case at a position spaced with a predetermined distance from the first circuit board and the second circuit board.

8. The folding-type portable wireless equipment according to claim 5, wherein a part of the antenna is disposed so as to protrude from an area sandwiched between the first circuit board and the second circuit board when viewed from a direction perpendicular to a plane of the portable wireless equipment in the opened state.
